(19) United States
(12) Patent Application Publication
(10) Pub. No.: US 2014/0281523 A1
(43) Pub. Date: Sep. 18, 2014

(54) System and method of secure remote authentication of acquired data

(71) Applicant: Vector Vex Inc., Santa Fe, NM (US)

(72) Inventor: Michael John Golino, Santa Fe, NM (US)

(21) Appl. No.: 13/802,644

(22) Filed: Mar. 13, 2013

(51) Int. Cl. H04L 29/06

(52) U.S. Cl. CPC H04L 63/0428
USPC 713/168; 726/4

(57) ABSTRACT

A computer-implemented method and an according system of secure remote authentication of acquired data is provided to allow a more secure and verifiable acquisition of digital data. The method may comprise exchanging between a user device and a security managing device seed information and generating synchronized random number time stamps on both devices based on the exchanged seed information, acquiring digital data using the user device, generating metadata with at least user time information upon acquisition of the digital data and providing authenticated digital data from at least the acquired digital data, the metadata and a user time stamp. Further, the method may comprise transmitting the authenticated digital data to the security managing device and verifying upon reception of the authenticated digital data, whether the user time information and the user time stamp of said authenticated digital data corresponds to verification time information and a correlating verification time stamp.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates to the field of computer science and more particularly but not exclusively, to data acquisition and authentication of acquired data.

### BACKGROUND

More and more computing devices such as in particular mobile devices, smart phones, tablet computers are today configured for the acquisition of digital data using integrated or attachable sensors. Exemplary types of such acquired data comprises images, audio or video recordings. Users rely on this functionality for example to make and share such data with friends using, e.g. social networking platforms.

Recent developments aim at using computing devices and in particular mobile computing devices for documenting purposes. For example, it is conceivable to use the integrated camera of a smart phone in law enforcement to provide photo evidence of a car accident or a parking citation. In another example, it may be conceivable to use a mobile tablet computer to generate a video documentation of the condition of a real estate property prior to a sale.

In all of the above examples however, the possibility of an easy alteration of accordingly acquired digital data may impede the use of this technology for documenting purposes. This may in particular be problematic in case the documentation is needed for legal purposes. For example, the validity of the acquired picture or video may depend on an unaltered acquisition date. As it is known, the alteration of the date of digital data is typically possible without great effort.

Accordingly, a method and system is needed to allow a more secure and verifiable acquisition of digital data.

### SUMMARY

The following summary of the present invention is provided to facilitate an understanding of some of the innovative features unique to the present invention and is not intended to be a full description. A full appreciation of the various aspects of the invention can be gained by taking the entire specification, claims, drawings, and abstract as a whole.

According to one aspect of the invention, a computer-implemented method of secure remote authentication of acquired data is provided. The method can be used with at least a user device and a security managing device.

In one non-limiting example, the method comprises exchanging between the user device and the security managing device seed information and generating synchronized random number time stamps (RNTS) on both devices based on the exchanged seed information, wherein at least one user time stamp is generated on the user device and one verification time stamp is generated on the security managing device. The non-limiting example may additionally or alternatively comprise correlating the generated verification time stamp with verification time information using the security managing device.

The non-limiting example may additionally or alternatively comprise acquiring digital data using the user device, generating metadata with at least user time information upon acquisition of the digital data and providing authenticated digital data from at least the acquired digital data, the metadata and the user time stamp.

The non-limiting example may additionally or alternatively comprise transmitting the authenticated digital data from the user device to the security managing device and verifying, using the security managing device and upon reception of the authenticated digital data, whether the user time information and the user time stamp of said authenticated digital data corresponds to the verification time information and the correlating verification time stamp.

In another aspect, a system of secure remote authentication of acquired data is provided with a user device and a remote device comprising a security managing device.

According to the present aspect, the user device comprises a data gathering module for acquiring digital data, a metadata generator for providing metadata with at least user time information upon acquisition of the digital data, a user random number generator for generating at least a user time stamp upon acquisition of the digital data, a user authenticating module and a first communication interface. The user authenticating module is configured for providing authenticated digital data from at least the acquired digital data, the metadata and the generated user time stamp. The first communication interface is adapted for transmitting the authenticated digital data.

Still according to the present aspect, the security managing device comprises a second communication interface adapted to communicate with the user device, a data verification module and a verification random number generator for generating at least one verification time stamp and correlating said verification time stamp with verification time information.

Still according to the present aspect and the system of secure remote authentication of acquired data, the user device and the security managing device are configured to exchange seed information, the user random number generator and the verification random number generator are configured for synchronized time stamp generation based on the exchanged seed information and the data verification module is configured to determine, whether the user time information and the user time stamp of the authenticated digital data correspond to the verification time information and the correlating verification time stamp.

The basic idea of one or more embodiments of the invention is to allow a synchronized operation of the user device and the security managing device so that the time and/or date of data acquisition by the user device can be verified by the security managing device without requiring a continuous connection between the devices.

Accordingly, the invention allows a remote verification of the authenticity of the digital data, which may be particularly beneficial for documentation applications such as for example, but not exclusively, in law enforcement, military, government applications, news, entertainment, sales, insurance, legal, architecture/construction, real estate, medicine or science.

In the following explanation of the present invention according to the embodiments described, the terms “connected to” or “connected with” are used to indicate a data connection/transmission link between at least two components, devices or modules. Such a connection may be direct between the respective components, devices or modules or indirect, i.e. over intermediate components, devices or modules. The connection may be permanent or temporary.

As mentioned in the preceding, the invention in one aspect refers to a system of secure remote authentication of acquired data with at least a user device and a remote device comprising a security managing device. Both, the user device and the remote device may be of any suitable type and in particular comprise a computing device, having at least a processor with a suitable programming to provide the functionality of at least some of the modules of the respective device. For example, the user device may be a mobile device, such as a laptop computer, smart phone, tablet, digital camera, portable medical device, scientific instruments, digital camera devices of automobiles, etc. The remote device may for example be a server system.

Any present or future user device that is capable of capturing a digital input and connectable to a network is envisaged and may depend on the particular application in industry. Some non-limiting examples of such applications and user devices are as follows. In law enforcement applications the user device may be by way of example a cell phone or other device camera and/or microphone for gathering evidence; a breathalyzer, such as for example a cell phone or other device—breathalyzer peripheral, or a parole monitor such as a cell phone or other device camera and/or microphone, GPS. In military applications, the user device may be a cell phone or other device, such as a wearable device, having for example a camera, microphone and/or GPS for documenting events, record orders, record movement of populations, crowds etc. The user device may be a surveillance camera, proximity sensor. In the government agency field, user devices may be a cell phone (or other device)—humidity—temperature—gps—cloud devices for weather monitoring, and cell phone (or other device)—camera, GPS, cloud, microphone devices for various applications such as noise abatement applications epidemiology applications and crisis management applications. In the field of news and entertainment, the user device may be a cell phone or other device having a microphone for documenting events, blogging, dating sites, social networks etc, In business applications the user device may be a cell phone camera for recording proof of delivery. In the insurance industry, the user device may be a cell phone camera for generating claim photographs (property and accident). The user device may be a cell phone or other device for legal applications involving capturing data for deposition, notary, contracts and/or evidence. In architecture—construction the user devices may be for example for recording seismic or vibration—cell phone [3-axis gyroscope; 3-axis accelerometers], documenting construction defects—cell phone [camera and or microphone], recording noise—cell phone [microphone], project management—cell phone [recording images or video, microphone], color matching, lighting design—cell phone [camera, ambient light sensor]. In real estate property documentation the user device may be for example a cellphone [camera, microphone, GPS]. In the field of Medicine, the user device may be for example in the diagnostics in the field—cell phone or other device with a camera, microphone, and one or more medical peripherals. Existing peripherals for cell phone are Glucose Meter, ECG Electrocardiogram, Blood Pressure Monitor, Pulse Oximeter, Ultrasound Imaging Device but medical user devices are not limited to having such as medical peripheral and other medical peripherals for capturing data are envisaged In scientific applications, example user devices are cell phones and other devices having cameras/GPS etc. for gathering data from remote sensors for sensing chemical agents, temperature, humidity, CO2 gas, vibration, tilt, collision, rotation, direction, orientation, metal content, etc. Also user devices including such sensors locally are envisaged. The cell phone or other user device may for example include 3-axis gyroscope, 3-axis accelerometers, 3-axis magnetometers sensors. Cell phones or other user devices can include 3-axis accelerometers—acceleration in the x-y-z space/vibration ambient light—Illuminance 3-axis Magnetometer-Location-direction (compass) 3-axis gyroscope—rotation in space—roll-pitch-yaw proximity—nearby objects, without any physical touch pressure—pressure used to determine altitude camera—images/video microphone—audio humidity—humidity temperature—temperature GPS/GLONASS.

The aforementioned examples of user devices are just some examples of user devices that are capable of capturing a digital input and connectable to a network. A person of ordinary skill would understand that such user devices are not limited to the use of phones or handheld devices but may include any size device depending on the industrial application.

Certainly, the system may comprise further devices or components or more than one user and/or remote device of the described configuration. In one particular non-limiting embodiment, the system may comprise multiple user devices, communicating with one remote device.

The user device comprises at least the data gathering module, the metadata generator, the user random number generator, the user authenticating module and the first communication interface.

A “random number generator” is used herein to mean a number generator capable of randomly generating numeric characters, alphanumeric characters, symbols, type printed symbols, letter, number or any combination thereof.

The data gathering module is configured for acquiring digital data, which in the context of the present invention may be any type of digital data. For example, the digital data may be text, entered by a user using a corresponding interface on the user device. In another example, the digital data may be a sensor reading of a sensor module, integrated with or connected to the user device, such as for example an accelerometer reading, an ambient light reading, the reading of a 3-axis magnetometer and/or 3-axis gyroscope, a proximity reading, a pressure reading, a humidity reading, temperature reading or positioning reading, EKG reading, pulse reading, blood pressure reading, location reading, geo-location reading, each of a corresponding sensor module or any other current or future device or sensor capable of capturing digital input.

In one embodiment, the digital data is multimedia digital data comprising any type of multimedia digital data, e.g. image, audio and/or video data. In this case, the data gathering module may in one embodiment comprise or be connectable to a camera and/or microphone.

The metadata generator is configured to provide metadata upon acquisition of the digital data by the data gathering module. Within the present explanation, the provided metadata is associated with the digital data, i.e. “descriptive metadata” and comprises at least user time information, such as the date and/or time of the acquisition of the digital data. To determine the user time information, the metadata generator may comprise a clock and/or may be connected to a timing module. The clock and/or timing module of the user device may be synchronized with the security managing device, e.g. upon an exchange of seed information, described in detail in the following.

The user device further comprises the aforesaid user random number generator, which serves to generate a user time stamp at least upon acquisition of the digital data by the data gathering module. As will be explained in the following in more detail, the user time stamp is a pseudo random number time stamp based on seed information and is used to verify the user time information on the side of the remote device, thus serving as a backup or verification “clock”.

As mentioned in the preceding, the user device further comprises the user authenticating module, which may be connected to the data gathering module, the metadata generator and the user random number generator and which is configured provide authenticated digital data from the digital data, the metadata and the user time stamp, received from the respective modules. The authenticated digital data is then provided to the connected first communication interface to be sent to the second communication interface of the security managing device with or without prior encryption.

Both mentioned communication interfaces of the devices may be of any suitable type to communicate with the respective other communication interface over a wired or wireless communication medium. For example, the first and/or second communication interface may be adapted for communication using the Internet Protocol over a LAN-, Cellular and/or Wifi-Network. Certainly, one or both of the communication interfaces may be adapted for further communication protocols, such as Bluetooth, IR-Transmission, Zigbee or any other suitable protocol. In case the first and second communication interfaces are not configured to operate with the same communication medium or protocol, the system may comprise an intermediate exchange device to allow the two interfaces to exchange information.

Besides the second communication interface, the security managing device further comprises the verification random number generator and the data verification module.

Corresponding to the operation of the user random number generator, the verification random number generator serves to generate at least one verification time stamp, i.e. a pseudo random number time stamp.

The generation of pseudo random numbers can be provided for example by pseudo random number techniques such as disclosed in for example Michael Luby, Pseudorandomness and Cryptographic Applications, Princeton Univ Press, 1996. A definitive source of techniques for provably random sequences. ISBN 9780691025469, which is incorporated herein by reference.

Furthermore, the verification random number generator is configured to correlate each verification time stamp with verification time information. In the present context, the verification time information may correspond to a date and/or time, so that it is possible for each generated verification time stamp to determine an associated date and/or time using the verification time information.

To provide this, the security managing device may for example be configured to store each generated verification time stamp with the correlating verification time information in a corresponding lookup table. To obtain the verification time information, the verification random number generator may comprise a clock and/or may be connected to a timing module.

The security managing device further comprises the data verification module, which may be direct or indirect connected with the second communication interface to receive the authenticated digital data, transmitted by the user device, and to the verification random number generator.

During operation of the inventive system according to the present aspect, the user device and the security managing device are configured to exchange seed information, e.g. using the first and second communication interfaces. The exchanged seed information is then transferred to the user random number generator and the verification random number generator for generation of the user time stamp and the verification time stamp, respectively.

While it may be sufficient to exchange seed information only once, it is conceivable that seed information is e.g. exchanged at given time intervals or upon each initialization of a user session such as upon power-up of the user device or start-up of a software package or “app”, enabling the functionality of the user device, explained above.

As will be apparent to one skilled in the art, the operation of multiple pseudo random number generators with common random seed information will lead to the generation of identical sequences of random numbers, which in terms of the present invention are employed to generate the at least one user time stamp and the at least one verification time stamp in a synchronized way.

The two random number generators can thus be considered as synchronized and secure “backup” clocks, since the time stamps can only be generated from the exchanged seed information, which certainly should upon the exchange only be available to the random number generators.

Accordingly, to keep the devices synchronized, a continuous data connection between the devices is not needed after the seed information is exchanged, which is particularly advantageous for mobile applications.

One or both of the random number generators may certainly be configured to generate a defined number of such random numbers and/or time stamps per given time interval. The respective time interval may be predefined in both devices or comprised in the seed information exchanged; for example, one or both of the random number generators may be configured to generate one random number and/or time stamp per second or alternatively one per minute or one per hour. Here, the verification number generator may be configured to correlate each generated verification time stamp with distinct verification time information.

When a data connection between the devices becomes available again, the user device, as discussed in the preceding, may send authenticated digital data to the security managing device, i.e. comprising the acquired digital data, the metadata with at least the user time information and the user time stamp.

The data verification module then determines whether the user time information and the user time stamp correspond to the verification time stamp and the correlating verification time information.

Accordingly, the system according to the present aspect advantageously allows for remote authentication of the digital data, i.e. to determine whether the user time information is correct and refers to the “true” time/date the digital data was acquired or has been altered, e.g. by a malicious user or during transmission of the authenticated digital data from the user device to the remote device.

Once the data has been verified by the data verification module, i.e. in case the user time information and the user time stamp correspond to the verification time stamp and the correlating verification time information, and in one embodiment, the data verification module may be further configured to store the authenticated digital data in a data repository database. The data verification module in this case only stores the data in the database upon successful verification. In case the data verification module determines that the data has been altered, the data verification module may be configured to discard the digital data.

The data repository database may be of any suitable type to store the authenticated digital data and should at least temporarily be connected with the data verification module. The data repository database may be an integral part of the remote device or may be formed separately there from. In one embodiment, the data repository database comprises a web server providing a web interface, so that an internet user may access the authenticated and verified digital data from the data repository database using e.g. the internet.

In a further alternative or additional embodiment, the data verification module is configured upon successful verification to encrypt the authenticated digital data and to store the encrypted digital data in an audit database.

The storage of the encrypted digital data in the audit database may be particularly useful in addition to the storage of the authenticated digital data in the data repository database, providing a backup copy of the digital data. The additional encryption further enhances the security of the overall system for example in case a malicious user should be seeking to alter the digital data once stored in the databases.

The data may be encrypted by any suitable encryption method. For example, the data may be encrypted using asymmetric key cryptography, for example public key cryptography. In the latter case, the decryption key (private key) may be provided only to a “trusted third party” (TTP), but not the user or the operator of the remote device, which further enhances the data integrity. In this case, the audit database may be considered as a “trusted third party audit database”.

For example, in case the system is used in law enforcement, the decryption key to access the digital data stored on the audit database may only be provided to an external independent expert, but not the law enforcement agency operating the system.

In a further embodiment, the security managing device and/or the data verification module is additionally configured to assign the authenticated digital data a serial data identifier and storing the serial data identifier with the authenticated data, e.g. in the data repository and/or audit database. The assignment of a unique “information” serial number for each digital data (transmission) enhances the security of the overall system further, since it increases the difficulty of maliciously “inserting” an entry into one of the databases.

The serial number in one example is based on the order the digital data, e.g. from multiple user devices, is received by the security managing device. In the above embodiment of a data repository database and a separate audit database, the digital data may be stored correspondingly in both databases.

Furthermore, it may be conceivable in another additional or alternative embodiment to store the serial data identifier together with the metadata of the digital data and/or the user time stamp in a transaction log database to further increase security. The transaction log database may be separate from the data repository database and the audit database. For example, the transaction log database may be formed integrally with the security managing device of the remote device.

In another example, it may be conceivable to store a checksum of the digital data or similar verification information in the data repository database, the audit database and/or the transaction log database.

According to a further embodiment, the metadata generator of the user device is configured upon acquisition of the digital data to generate metadata with at least the user time information and additional location information. Such location information may e.g. be determined from a positioning module, e.g. arranged integrally with the user device. For example, the positioning module may be a satellite positioning module for operation with the GPS, Galileo and/or Glonass or similar global positioning systems.

The location information may be of any suitable type. For example, the location information may comprise the longitude/latitude of the user device during data acquisition.

In case the positioning module is a satellite positioning module, the typically used satellite timing signals may be further employed to generate the user time information or additional backup user time information on the user device. Since in this case, the time information is correlated with the location information, the present embodiment enables to further verify the location information using the process described in the preceding. The metadata generator may be configured to include the backup user time information in the generated metadata.

In another embodiment, metadata generator of the user device is configured upon acquisition of the digital data to generate metadata with at least the user time information, location information and a predefined user identifier. The predefined user identifier may be of any suitable type and is a unique identifier of the respective user device in the system, i.e. at least system-wide. The predefined user identifier may for example be derived from a serial number of the user device, an international mobile equipment identity number (IMEI), a cellular data number (CDN), a phone number, MAC address, CPU serial number, hardware UUID or an integrated circuit card ID number (ICCID). Alternatively or additionally, the predefined user identifier may be assigned by the security managing device and transmitted to the user device, e.g. during an initialization stage, as will be explained in the following.

In the present embodiment, the generated metadata including the predefined user identifier may be for example stored in the data repository and the audit database. Furthermore, the predefined user identifier may be stored in the transaction log database to further increase the security of the system.

According to another alternative or additional embodiment, the user device and/or the security managing device comprise a transmission encryption module configured to generate at least one transmission encryption key in an initialization stage prior to the exchange of the seed information. As will be explained in the following, the transmission encryption key may be used to enhance the security of the further communications between the devices and may be of any suitable type.

The transmission key may for example be generated on the side of the security managing device and then transferred to the user device or vice versa. In an alternative embodiment, the transmission key is generated by both devices, for example using an encrypting one time password (EOTP) protocol as known in the art. The EOTP protocol is a cryptographic one time password protocol (OTP) designed to provide a static encryption key across login sessions. EOTP is for example explained at http://defuse.ca/eotp.htm.

For example, the user device and the security device may be configured to exchange random numbers and to generate the transmission key(s) from the random numbers. After the generation of the key(s), the random numbers may be safely discarded.

In one embodiment, the transmission key is used to exchange the seed information. For example, the security managing device may be configured to generate the seed information, then e.g. using the transmission encryption module, encrypt the seed information with the transmission encryption key and transmit the encrypted transmission encryption key to the user device.

In another additional or alternative embodiment, the user device, e.g. using the transmission encryption module of the user device, may be configured to encrypt the authenticated digital data using the transmission encryption key prior to transmitting the authenticated digital data to the security managing device. In this case, the transmission encryption module of the security managing device may additionally be configured to decrypt the authenticated digital data using the transmission encryption key.

In another embodiment and prior to the generation of the transmission encryption key, the initialization stage may comprise a method to check the integrity of the user device to determine, whether the security managing device can trust this device. For example, it may be possible that a malicious user tampered with the device to compromise the security of the system. Certainly, in such case, no further data should be exchanged between the devices.

In one particular embodiment, the user device during the initialization stage is configured to provide device information of one or more parameters of the user device and to transmit the device information to the security managing device.

For example, the device information may comprise information about make and model of the user device, serial number, operating system version, installed software, installed hardware features, such as CPU or memory size, MAC address, IMEI, mobile equipment identifier (MEID), cellular data number (CDN) and/or integrated circuit card ID (ICCID).

In a further embodiment, the security managing device, upon reception of said device information determines, whether the received device information corresponds to predefined device attestation information, i.e. to one or more expected device parameters of a device which has not been tampered with, e.g. parameters of the respective device in original equipment manufacturer condition. Only in case the device information corresponds to the predefined device attestation information, the transmission encryption key is generated. Otherwise, the security managing device stops communicating with the user device which is then considered unsafe.

In another additional or alternative embodiment, the security managing device upon reception of the device information is configured to store the device information in the transaction log database.

The device information of the transaction log database may be used for example to determine, whether an unsafe device, which connected the security managing device before, makes another attempt to connect. In this case, the security managing device may be configured to reject further communication with this device without further checks. Furthermore, the transaction log database may additionally or alternatively be used to determine, whether the user device, its operating system and/or the installed software, has been altered after the last initialization of a user session. Accordingly in another embodiment, the security managing device may be configured to determine, whether the received device information corresponds to stored device information comprised in the transaction log database, so that the transmission key is only then generated, when the received device information corresponds to the stored device information of the transaction log database.

These and other aspects of the invention will be apparent from and elucidated with reference to the embodiments described hereinafter.

### BRIEF DESCRIPTION OF THE DRAWINGS

In the drawings,

FIG. 1 shows an embodiment of a system of secure remote authentication of acquired data comprising a user device and a remote device according to one aspect of the present invention in a schematic view,

FIG. 2 shows an exemplary schematic detailed view of a user device for use with the embodiment of FIG. 1,

FIG. 3 shows an exemplary schematic detailed view of a security managing device for use with the embodiment of FIG. 1,

FIGS. 4 and 5 show the operation of the system during an initialization stage according to the embodiment in FIG. 1 in a schematic flow chart,

FIGS. 6 to 10 show the operation of the system during a user session for data acquisition according to the embodiment in FIG. 1 in a schematic flow chart and

FIG. 11 schematically shows the storage of device session records in a transaction log database.

### DETAILED DESCRIPTION OF PREFERRED EMBODIMENTS

FIG. 1 shows an embodiment of a system 1 of secure remote authentication of acquired data according to one aspect of the present invention in a schematic view. The system 1 comprises at least one user device 2 and a remote device 3, connected with each other over a data network 4, such as the Internet.

The system 1 allows to automatically remote verifying the authenticity of (electronic) data that has been acquired/captured by a user of a user device 2 and subsequently uploaded to remote device 3. The system 1 in particular allows to verify that the time of data acquisition has not been altered, but also that the data itself and further metadata, such as location information, has not been manipulated after the acquisition of the data. Furthermore, the system 1 allows to verify the “provenance” of the data, i.e. that every step of the acquired/captured data can be accounted for.

The system 1 may be particularly beneficial for documentation applications such as for example, but not exclusively, in law enforcement, military, government applications, news, entertainment, sales, insurance, legal, architecture/construction, real estate, medicine or science. Certainly, the system 1 may be employed for any other application where it is essential to ensure that the acquired data is not altered after its acquisition.

The system 1 comprises at least the one user device 2, which according to the present embodiment is a smart phone comprising a first wireless communication interface 5 and a processor 6. The first wireless communication interface 5 is configured for wireless transmission of data using a cellular network 13. The processor 6 comprises memory (not shown) with suitable programming to provide the operation, described in detail in the following with reference to FIGS. 4-11. The user device 2 further comprises a camera 11 to obtain multimedia, e.g. audio, image or video digital data. In addition, positioning module 12 provides geo-location information, e.g. from a satellite positioning system such as GPS, Glonass or Galileo. As can be seen from FIG. 1, the first communication interface 5, the camera 11 and the positioning module 12 are connected with the processor 6.

In the present explanation of the preferred embodiments, the terms “connected to” or “connected with” are used to indicate a data connection/transmission link between at least two components, devices or modules. Such connection may be direct between the respective components, devices or modules or indirect, i.e. over intermediate components, devices or modules. The connection may be permanent or temporary.

The remote device 3 comprises a security managing device 7, comprising a second communication interface 8, a central processor 9 and a transaction log database 10. The security managing device 7 may be for example a computing device, such as a server. The second communication interface 8 according to the present example is a network interface for connection to the data network 4 over a security firewall 14, indicated in FIG. 1 as a dotted/dashed line. The central processor 9 of the security managing device 7 comprises, in correspondence with the user device 2, memory with programming, as will be explained in the following in more detail. The second communication interface 8 and the transaction log database 10 are connected with the central processor 9.

The remote device 3 further comprises a data repository database 15, connected to a web server 16. The web server 16 allows the second communication interface 8 of the security managing device 7 communicate with the data repository database 15 directly, i.e. through the security firewall 14 and using “non-public” connections. The connection from the web server 16 to the second communication interface 8 is highly restricted so that in this direction no digital data may be sent from the web server 16 to the communication interface 8. Certainly, information such as server logs, web stats and other web session information my pass the security firewall 14 in this direction.

The web server 16 however also connects the data repository database 15 to the data network 4 through a typical web server firewall 17, so that data on the database 15 can be accessed by a computer 18, which is also connected to the data network 4. However, the access to the database from the data network 4 is restricted to read-only access, so that it should not be possible to alter data, stored in the database 15 through this connection.

The remote device 3 further comprises an audit database 19, connected with the second communication database 8. The audit database 19, in contrast to the data repository database 15, is not directly connected to the data network 4 to enhance the security of the data stored therein. Access to the audit database 19 is only possible through the security managing device 7, e.g. by “logging-in” to this device. As will be explained in more detail in the following, the audit database 19 serves as a backup to the data repository 15 in case a malicious user should try to break-in and alter data on the data repository database 15. To improve security, data on the audit database 19 is stored in an encrypted format.

FIG. 2 shows a detailed schematic view of the user device 2 for use with the embodiment of FIG. 1 The user device 2 as shown comprises the first communication interface 5, the processor 6, the camera 11 and the positioning module 12. As discussed in the preceding, the processor 6 comprises memory (not shown) with programming, which is represented in FIG. 2 as software modules 20-24.

In particular, the processor 6 comprises a data gathering module 20, connected with the camera 11. The data gathering module 20 serves to acquire digital data using the camera 11, which is in the present embodiment digital multimedia data, e.g. image, video and/or audio digital data. The data gathering module 20 may be activated by a user using a user interface (not shown) of the user device 2.

Further, a metadata generator 21 is arranged to provide metadata with at least user time information, i.e. date/time of image acquisition from a user timing/clock module (not shown), location information from the connected positioning module 12 and a user device identifier. A user random number generator 22 is provided to generate at least one user time stamp upon acquisition of the digital data, based on seed information, exchanged with the remote device 3. As will be apparent from FIG. 2, the aforesaid software modules 20-22 are connected with a user authenticating module 23 to provide authenticated digital data from the acquired digital data, the metadata and the generated user time stamp. The user authenticating module 23 is connected with transmission encryption module 24, which then sends encrypted and authenticated digital data to the remote device 3 using the first communication interface 5. The transmission encryption module 24 in general allows to en- and decrypt messages, exchanged with the remote device 3.

FIG. 3 shows a detailed schematic view of the security managing device 7 for use with the embodiment of FIG. 1. The security managing device 7 comprises, as discussed in the preceding, the second communication interface 8, the central processor 9 and the transaction log database 10. The central processor 9 comprises memory (not shown) with programming, which is represented in FIG. 3 as software modules 30-32.

The processor 9 comprises a transmission encryption module 30, in correspondence with the user device 2 to en- and decrypt transmissions exchanged with the user device 2. Furthermore, verification random number generator 32 is present to generate at least one verification time stamp from the exchanged seed information and correlating the verification time stamp with verification time information, i.e. date and/or time information. The verification time information may be provided by a verification timing/clock module (not shown).

Additionally, a data verification module 31 is present and configured to determine, whether the user time information and the user time stamp of the authenticated digital data correspond to the verification time information and the correlating verification time stamp, i.e. to determine whether all recorded times and time stamp match up and thus whether the digital data is authentic and unaltered.

To set-up the system 1, both devices 2, 7 first operate in an initialization stage, which in the following will be explained with reference to the flow chart of FIGS. 4 and 5. The initialization stage begins with the user downloading a software package or “app” from an application server, such as an “app store” in step 40. The app is consecutively installed on the user device 2 in step 41 upon which the processor 6 is programmed with the software modules explained in the preceding with reference to FIG. 2. In case the installation fails, the initialization stage is aborted in step 42.

In case of a successful installation, the user device 2 contacts the security managing device 7 using the first communication interface 5 (not shown in FIG. 4) and the second communication device 8 through a secure protocol like HTTPS. The security managing device 7 the prompts the user device 2 to start a “remote attestation” subroutine in step 43a. In parallel in step 43b, the security managing device 7 creates a device record 50 with a new unique user device identifier (DISN) creates a log file and logs for this session in the transaction log database 10. In particular, the user device identifier may be a serial user device identifier, assigned serially to subsequently set-up different user devices 2. The DISN number is transmitted to the user device 2.

Upon reception of the request to start the remote attestation subroutine by the user device 2 in step 44 the user device 2 runs a subroutine that inventories in step 45 device information of one or more parameters of the user device, for example:

### Model

Serial number
OS and OS version
All installed software
All hardware features (cpu, memory size etc)

In step 46, the user device 2 consecutively uploads the user device information to security managing device 7, then the further initialization stage pauses, waiting for a “continue” command from the security managing device 7. The security managing device 7 compares the user device information with device attestation information, which may comprise manufacturer specifications stored in the transaction log database 10. In particular, the security managing device 7 “looks” for installed software that might be suspicious, i.e. a jailbreak software or other software to modify the operating system installed.

If the comparison does not match or if suspicious software is found, the security managing device 7 messages an “abort” command, upon which the initialization stage is aborted in step 42. The same may apply in case it is found that the device is “jailbroken”.

If the comparison matches and no suspicious software is detected, the security managing device 7 messages a “continue” command to the user device 2 and stores the user device information in the record 50 of the transaction log database 10, corresponding to the user device's DISN.

In step 47, the user device 2 continues with the remote attestation subroutine to detect if the “app” is running in a virtual machine and/or in a debugger mode. Furthermore, the user device 2 determines, whether the checksum of the downloaded app is correct. If the above is not the case, the further initialization stage is aborted in step 42. Otherwise, the user device in step 48 runs a further subroutine to detect as much additional device information, such as hardware identifiers as possible. These include but are not be limited to:

### Make/Model

Serial number
Mac address (Wifi and Bluetooth)
International Mobile Equipment Identity (IMEI) number

### Mobile Equipment Identifier (MEID)

### Cellular Data Number (CDN)

### Integrated Circuit Card ID (ICCID).

In step 49, the user device 2 transmits the additional device information and checksum data to the security managing device 7, upon which the security managing device 7 records the uploaded device information into the associated record 50 on the transaction log database 10 for the present DISN. In the event that the initialization stage or remote attestation process fails at any point, the security managing device 7 makes a record of the process completed to that point and stores information in the record associated with that DISN.

Otherwise, in step 51 the security managing device 7 determines that the user device 2 has been verified. An according message is sent to the user device 2 in step 52 so that the initialization stage can continue in step 53.

In step 53, shown in FIG. 5, the user device 2 then prompts the security managing device 7 that the exchange of a transmission encryption key can now start in a device encryption sequence key (DESK) process. The transmission key according to the present example is a device encryption sequence key (DESK), used as the static encryption key used in a EOTP scheme and is generated for each message and data transfer between the user device 2 and the security managing device 7. EOTP is a cryptographic One Time Password (OTP) protocol designed to provide a static encryption keys across a single login sessions.

In steps 54a, 54b the user device 2 and the security managing device 7 start the DESK process, upon which both devices 2, 7 synchronize. User device 2 sends random numbers to the security managing device 7. The transmission encryption module 30 of the security managing device 7 then calculates and sends hashed keys to the transmission encryption module 24 of user device 2 in steps 55a, 55b. The transmitted random numbers of the user device 2 are then safely deleted. As a result, a static key is generated by the user device 2 in step 56a. The security managing device 7 in step 56b calculates a cryptic master key which is then stored in the corresponding transmission encryption module 30 of the security managing device 7 in step 57. The devices 2, 7 then communicate the successful generation of the keys to each other. Now both devices 2, 3 have private keys and a shared public (transmission encryption) key for the encrypted transmission of data. In step 58, the transmission (DESK) encryption keys (static & master) are ready on both the user device 2 and the security managing device. The installation and initialization stage process on the user device 2 is now complete and then ends with a reboot of the user device 2. The user device 2 is now ready for data acquisition in one or more user sessions. Typically, the initialization stage is only conducted once.

FIGS. 6 to 9 show the operation of the system 1 according to the embodiment in FIG. 1 during a user session for data acquisition in a further schematic flow chart.

The user session begins in step 60 with the user launching the software package or “app” on the user device 2, i.e. causing the aforesaid software modules to be executed by the processor 6 by a corresponding button on the user interface. In case the software package fails to load the user session is aborted in step 61.

Upon successful launch, the user device connects with the security managing device 7 through a secure protocol, for example HTTPS, using the previously generated transmission encryption key to start/initialize the user session. Although not expressly mentioned in the following, all transmissions between the devices may certainly be encrypted using the previously generated transmission encryption keys.

The security managing device 7 queries the transaction log database 10 in step 62 to receive the record associated with the user device 2 according to the DISN of the user device 2. In case the user device 2 is already initialized and not suspicious or flagged for some reason, the security managing device 7 continues with step 63. Otherwise the user session is aborted in step 61.

In step 63, the security managing device 7 the prompts the user device 2 to start the “remote attestation” subroutine for a security check. Although a remote attestation has been conducted during the initialization stage, the repeated procedure assures that the user device 2 has not been modified between the initialization stage and the start/initialization of the user session, thus improving the security of the system further.

Upon reception of the request to start the remote attestation subroutine by the user device 2 in step 64 the user device 2 runs a subroutine that inventories in step 65 device information of one or more parameters of the user device, for example:

### Model

Serial number
OS and OS version
All installed software
All hardware features (cpu, memory size etc)

In step 66, the user device 2 consecutively uploads the user device information to security managing device 7, then the further initialization of the user session pauses, waiting for a “continue” command from the security managing device 7. The security managing device 7 compares the user device information to with device attestation information, which may comprise manufacturer specifications stored in the transaction log database 10. In particular, the security managing device 7 “looks” for installed software that might be suspicious, i.e. a jailbreak software or other software to modify the operating system installed.

If the comparison does not match or if suspicious software is found, the security managing device 7 messages an “abort” command, upon which the initialization of the user session is aborted in step 61. The same may apply in case it is found that the device is “jailbroken”.

If the comparison matches and no suspicious software is detected, the security managing device 7 messages a “continue” command to the user device 2 and stores the user device information in the record 50 of the transaction log database 10, corresponding to the user device's DISN.

In step 67, the user device 2 continues with the remote attestation subroutine to detect if the “app” is running in a virtual machine and/or in a debugger mode. Furthermore, the user device 2 determines, whether the checksum of the downloaded app is correct. If the above is not the case, the further initialization of the user session is aborted in step 61. Otherwise, the user device in step 68 runs a further subroutine to detect as much additional device information, such as hardware identifiers as possible. These include but are not be limited to:

### Make/Model

Serial number
Mac address (Wifi and Bluetooth)
International Mobile Equipment Identity (IMEI) number

### Mobile Equipment Identifier (MEID)

### Cellular Data Number (CDN)

### Integrated Circuit Card ID (ICCID).

In step 69, the user device 2 transmits the additional device information and checksum data to the security managing device 7, upon which the security managing device 7 compares the uploaded device information and the checksum with the associated record 50 on the transaction log database 10 for the present DISN to make sure that the data matches.

In the event that the session start-up/initialization or the remote attestation process fails at any point, the security managing device 7 makes a record of the process completed to that point and stores information in the record 50 associated with that DISN. The session is then aborted in step 61.

In case the uploaded device information and checksum data matches the ones on the record 50, the security managing device 7 determines that the user device 2 has been verified in step 70. An according message is sent to the user device 2 so that the user session can continue.

As can be seen from the continued flowchart of FIG. 7, in step 71 the user device 2 prompts the security managing device 7 to continue with the user session. In step 72, the user device 2 sends the user device identifier (DISN) together with present user time information, i.e. the present time according to the user device 2, the location information and a new transmission encryption key, to the security managing device 7 for use in the present user session. As mentioned above, the transmission encryption keys are only valid for one session. The new key is transmitted via HTTPS. All further transmissions of the user device 2 are then encrypted with the new transmission encryption key.

Upon reception of the aforesaid data by the security managing device 7 in step 73, the security managing device 7 generates a device session record 74 for the current user session, which is stored in the device record 50 on the transaction log database 10 for the present DISN, which may include the time and location of the last “log-in” or start-up of a user session, the transmission keys used, the last user time stamps provided together with the session logs. In case no device session record 74 can be found, a new one is created.

In step 75, the security managing device 7 applies a fraud detection algorithm verifies the received user time information and the location information compared to the last login, if comprised in the device session record 74. If this algorithm fails, the user session is aborted in step 61. Otherwise the security managing device 7 sets the DESK configuration values to be send back to the user device 2 in step 76. The local DESK keys are to be used internally within the system. The security managing device 7 logs all pertinent information in the device session record 74. For example, the location information transmitted may be compared with the location information transmitted in a prior session in a fraud detection reasonability check. Fraud may e.g. be detected in case the change in location may not be conducted between the login times in a reasonable way. For example, it may not be feasible that a change in location between New York and Los Angeles is conducted in one hour time.

In step 77, the security managing device 7 generates seed information for random number generation and provides the seed value to the verification random number generator 32. Based on the seed information, the verification random number generator 32 now generates a verification time stamp each second and stores the generated time stamps in an internal database together with the respective present verification time information, i.e. the date/time in which the time stamp was generated and thus correlates to the time stamp. The internal database may comprise the following information:

| Verification Time Stamp | Verification Time Information |
|---|---|
| 18376894387 | Feb, 20 2013 3:30:00 PM |
| 17830958760 | Feb, 20 2013 3:30:01 PM |
| 18495094378 | Feb, 20 2013 3:30:02 PM |
| . . . | . . . |

Certainly, as will be apparent to one skilled in the art, a different time interval of random number time stamp generation and/or a different format may be chosen.

The security managing device 7 then in step 78 transmits the seed information to the user device 2 together with time synchronization information, so that the user timing/clock module (not shown) is synchronized with the verification timing/clock module (not shown). In addition, the seed information is stored in the device session record 74 of the transaction log database 10. Upon reception of the aforesaid transmission by the user device 2 in step 79, the generation of user time stamps by the user random number generator 22 is initiated in step 80, based on the seed information. The user device in step 81 uploads the “start” time and the “seed” values to the security managing device 7. The security managing device 7 in step 82 stores the received start time and value in the device session record 74 and then is set to an idle-mode in step 83.

On the side of the user device 2, the user random number generator 22 then, corresponding to the verification random number generator 32, generates a user time stamp each second in a background process in step 84.

The user device 2 then continuously monitors the device for any abnormal operation beginning in step 84, which may be a sign of a malicious user, trying to tamper with the system. In this case, the operation is aborted in step 61.

In step 85, the user device 2 and the security managing device 7 are synchronized, i.e. the time stamp generation on the time stamp generators 22, 32 is synchronized. The start-up of the user session is complete, so that it is now possible to acquire digital data with the user device 2 beginning in step 86.

Once the synchronized time stamp generation on the user device 2 and the security managing device 7 is started, the data connection between the devices may be shut down, allowing an independent operation of the user device 2, even in case no network connection should be available.

The acquisition of digital data with the user device subsequently begins in step 87, shown in the continued flow chart of FIG. 8.

In step 88, the user sets capture preferences of camera 11, such as exposure, flash on/off, zoom, etc. The software modules or the “app” on the user device 2 however, limit the capture functionality so that the user only can set pre-determined parameters of the camera 11, thus limiting potential for creating forged or inaccurate data.

In step 89, the acquisition/capture of for example image digital data is initiated, for example by the user activating a corresponding button on the user device 2. The camera 11 subsequently acquires the image in step 90, which is then transferred to the data gathering module 20. The data gathering module 20 accordingly informs the metadata generator 21 and the user random number generator 22 of the image digital data acquisition. In step 91, the metadata generator 21 generates metadata with at least the present user time information from the user timing/clock module (not shown) and the location information obtained from positioning module 12. Simultaneously, the user random number generator 22 provides the user time stamp, corresponding to the time of image data acquisition. The image digital data, the metadata and the user time stamp is then transferred to the user authenticating module 23.

In step 92, the image is previewed to the user, e.g. using a screen of the user device 2. In case the user does not accept the captured image, the image digital data as well as the metadata and the time stamp are deleted from the user device in step 93. The user device in step 94 is then again set to acquire digital data and returns to step 87.

In case the user accepts the image, the user authenticating module 23 in step 95 provides authenticated digital data from the acquired image digital data, the metadata and the user time stamp. The authenticated digital data is then encrypted by the transmission encryption module 24. The user device, if connected to the data network 4, then messages to the security managing device 7 to receive the encrypted and authenticated digital data in step 96. Otherwise, the encrypted and authenticated digital data is stored for later transmission.

If a connection to the data network 4 and thus to the security managing device 7 is available, the security managing device 7 upon reception of the message of the user device 2 returns from the idle-mode in step 97 and prepares for data reception.

In step 98, the encrypted digital data is transmitted to the security managing device 7. Simultaneously, the user device is again set to acquire digital data in step 99.

As can be seen from the continued flow chart of FIG. 9, the encrypted data is received by the security managing device 7 in step 100. The data is subsequently decrypted by the transmission encryption module 30 of the security managing device 7 in step 101.

In step 102, the decrypted data is provided to the data verification module 31 which queries in step 104 the verification random number generator 32 to provide the verification time stamp, for which the verification time information corresponds to the user time information.

Accordingly in step 105, the data verification module 31 determines, whether the user time stamp of the authenticated digital data corresponds to the verification time stamp, provided by the random number generator 32. If the time stamps should not match, the authenticated digital data is deleted, the deletion is noted in the device session record 74 in step 106.

In case the time stamps match, a serial data identifier (INSN) is assigned to the digital data in step 107. Subsequently in step 108, the data verification module 31 creates a new data record 109 for the acquired digital data and uses the assigned serial data identifier as a “name” of the record 109. The data record 109 then comprises:
DISN & INSN
Transmission encryption (DESK) session key
Random number time stamp resolution information
The acquired/captured digital data
The associated metadata
Time and location of the user device 2 upon session start
Session start/stop session logs.

The above data record 109 comprising the acquired digital data is used to create a capture data record 130 in the data repository database 15 in step 110, so that, as discussed in the preceding, the stored data on the database 15 can be accessed by a computer 18, which is also connected to the data network 4. In step 111, data record 109 is used to create an encrypted capture data record 131, i.e. encrypted with an asymmetric encryption method, such as a public/private key encryption method, and then stored on the audit database 19.

The data record 131 on the audit database 19 serves for verification purposes and may be accessed only by a trusted third party having the private key in step 112. For example within the field of law enforcement, it may be required to assure that the data record 131 has not been altered after its storage on the data repository database 1.

Here, the private key may be provided to an external expert only to verify that the data records 130, 131 in both databases 15, 19 are showing identical information. Accordingly, an alteration by a user from “breaking” into web server 16, but also by the system operator, would be easily detectable to the expert, making the system extremely robust against attempts to modify the digital data after its acquisition.

Once the data records 130, 131 are stored in the data repository database 15 and the audit database 19, the security managing device 7 returns to idle-mode. On the user device 2, the user session may be shut down by the user or remain active in case the user decides to acquire more data as discussed in the preceding with reference to the flow chart of FIG. 8.

The shut down of the user session will in the following be explained with reference to the schematic flow chart in FIG. 10. The process begins with the user initiating the shut down process in step 115, e.g. by pressing a corresponding button on the user device 2. The user device 2 then in step 116 informs the security managing device 7 of the initiated shut down process in step 116. In case no connection to the data network 4 should be available, certainly no messages are sent to the security managing device 7 and the user device 2 continues with the shut down process.

The user device 2 in step 117 obtains the device identifier (DISN) assigned from its memory, the present user time information from the user timing/clock module, the location information from the positioning module 12 and the transmission encryption keys to be used for the next user session. The aforesaid information is transmitted to the security managing device 7 in step 118 if a data connection is available.

Upon reception of the aforesaid information in step 119, the security managing device 7 stores the obtained user time information, location information and the transmission encryption keys in the device session record 74 associated with the user device identifier (DISN) of the user device 2.

The user device 2 in step 120 stops the user random number generator 22 and sends the final time stamp generated and the associated user time information to the security managing device 7 in step 121. Upon reception by the security managing device 7 in step 122, the synchronized generation of verification time stamps within the verification random number generator 32 is stopped. Certainly, in case further user devices have user sessions setup with the security managing device 7, the synchronized generation of verification time stamps for these other devices is continued.

In step 123, data verification module 31 of the security managing device 7 checks the received user time information and user time stamp against the verification time information and verification time stamp, as discussed in detail in the preceding. In case the time stamps and the time information match, the user time information and the user time stamp is uploaded to the device session record 74 stored in the transaction log database 19 as part of the device record. In case the time stamps and the time information do not match, the user time information and the user time stamp is again uploaded to the device record, but marked as suspicious.

Finally, the software modules or “app” on the user device 2, providing the above operation is shut down in step 124.

In case the user initiates a shut down without connection to the data network 4, in case of a crash or a failure to complete the shutdown process, this fact will be noted in the device record 50 associated with the DISN of the user device 2 upon the next start-up of a user session. Since the present invention seeks to guarantee the integrity of the acquired data, it may then be possible to apply algorithms to monitor device records with bad shut downs to determine user devices, where the user behavior indicates attempts to “break” the system 1.

FIG. 11 schematically shows the storage of data records 109a-109f in a transaction log database. As will be apparent from the figure, in the present example, two user devices 2a and 2b are connected with the security managing device 7. As discussed in the preceding with reference to FIG. 4, a user device identifier (DISN) is assigned to each user device 2a, 2b upon initialization stage. The user device identifiers are assigned by the security managing device 7 in a sequential way. In the present example, user device 2a registered first and was assigned the DISN 0001. Upon the subsequent registration of the user device 2b, the device 2b was assigned the DISN 0002. As discussed above, the user device identifiers are stored in corresponding device records 50 in the transaction log database 10.

As further discussed in the preceding, upon reception of authenticated digital data by the security managing device 7, a serial data identifier (INSN) is assigned in a sequential way to the digital data and the data records 109a by the security managing device 7. In the example shown in FIG. 11 user device 2a transmits digital data first, i.e. data record 109a, to which the INSN 0001 is assigned. The subsequent transmission of digital data by the user device 2b is assigned the INSN 0002. The serial data identifiers are thus assigned by the security managing device 7 independent of the user device identifier. All identifiers are, as explained in the preceding, stored in the device session records 74 of the respective user sessions in the transaction log database 10.

As will be apparent from FIG. 11, the assignment of the user device identifiers and the serial data identifiers further enhance the security of the system 1, since in case a malicious user would try to insert a data record 109 a-109f into the databases 15, 19, it is possible to check whether the user device identifier and the serial data identifier, stored in the corresponding data record 130 of e.g. the data repository database 15 corresponds to the identifiers stored in the transaction log database 10.

It should be noted however, that the serial data identifier should preferably be created by the security managing device 7, independent of the user devices 2a, 2b.

The described procedure creates a second level of data validation, based upon a determination of a logical break in the sequence of assigned identifiers, also referred to as “referential integrity”.

While the invention has been illustrated and described in detail in the drawings and foregoing description, such illustration and description are to be considered illustrative or exemplary and not restrictive; the invention is not limited to the disclosed embodiments.

For example, it is possible to operate the invention in an embodiment wherein
the system 1 comprises more than one user device 2,
at least one user device 2 is not a smart phone, but a further device allowing data acquisition, e.g. a mobile device, such as a laptop computer, tablet, digital camera, portable medical device, scientific instruments, digital camera devices of automobiles, or any other current of future user device that is capable of capturing a digital input and connectable to a network etc.,
the user device 2 is connected to the data network 4 using a Wifi connection, Bluetooth connection, cable connection or any other type of suitable data connection,
the user device 2, instead of or additionally to the camera 11, is configured to acquire text digital data, audio digital data and/or sensor digital data of a sensor module integrated with or connected to the user device 2,
the digital data, instead of or additionally to comprising multimedia digital data, comprises sensor digital data such as for example an accelerometer reading, an ambient light reading, the reading of a 3-axis magnetometer and/or 3-axis gyroscope, a proximity reading, a pressure reading, a humidity reading, temperature reading or positioning reading and/or
instead of or additionally to obtaining the user time information from the user timing/clock module, obtaining the user time information from the positioning module 12.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit may fulfill the functions of several items recited in the claims.

The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

What is claimed is:

1. A computer-implemented method of secure remote authentication of acquired data using at least a security managing device comprising:
exchanging, using the security managing device, seed information with a user device to provide synchronized time stamp generation with the user device,
generating, using the security managing device, at least one verification time stamp based on the exchanged seed information,
correlating, using the security managing device, the generated verification time stamp with verification time information,
receiving, from the user device, authenticated digital data comprising digital data, a user time stamp and metadata, wherein the metadata comprises at least user time information and
verifying, using the security managing device, whether the user time information and the user time stamp of said authenticated digital data correspond to the verification time information and the correlating verification time stamp.

2. The method of claim 1, wherein upon successful verification further storing the authenticated digital data in a data repository database.

3. The method of claim 2, wherein upon successful verification further encrypting the authenticated digital data and storing the encrypted digital data in an audit database.

4. The method of claim 2 or 3, wherein prior to storing the authenticated digital data and using the security managing device, assigning the authenticated digital data a serial data identifier and storing the serial data identifier with the authenticated digital data.

5. The method of claim 2 or 3, wherein upon storing the authenticated digital data and using the security managing device, storing at least a predefined user device identifier received from the user device, the metadata and the serial data identifier in a transaction log database.

6. The method of claim 1, wherein prior to the exchange of seed information at least a transmission encryption key is generated during an initialization stage.

7. The method of claim 6, wherein the transmission encryption key is generated using an encrypting one time password protocol.

8. The method of claim 6 or 7, wherein the step of exchanging seed information comprises, using the security managing device:
generating the seed information,
encrypting the seed information with the transmission encryption key and
transmitting the encrypted seed information to the user device.

9. The method of claim 6, wherein prior to verifying that the user time information and the user time stamp correspond to the verification time information and the verification time stamp, decrypting the encrypted authenticated digital data using the transmission encryption key.

10. The method of claim 6, wherein the initialization stage comprises:
receiving from the user device, device information of one or more parameters of the user device and
determining, using the security managing device, whether the received device information corresponds to predefined device attestation information, so that the transmission encryption key is only generated, in case the received device information corresponds to the predefined device attestation information.

11. The method of claim 10, wherein upon reception of the device information using the security managing device, the device information is further stored in the transaction log database.

12. The method of claim 11, further comprising the step of determining, using the security managing device, whether the received device information corresponds to stored device information comprised in the transaction log database, so that the transmission encryption key is only generated, in case the received device information corresponds to stored device information.

13. The method of claim 1, wherein said digital data is multimedia digital data.

14. A computer-readable medium including contents that are configured to cause a computing system to conduct the method of claim 1.

15. A remote device comprising a security managing device, the remote device forming part of a system of secure remote authentication of acquired data, the security managing device comprising:
a communication interface, adapted to communicate with a user device to receive authenticated digital data, which authenticated digital data comprises at least digital data, a user time stamp and metadata, wherein the metadata comprises at least user time information,
a verification random number generator for generating at least one verification time stamp and correlating said verification time stamp with verification time information and
a data verification module, wherein
the security managing device is configured to exchange seed information with the user device,
the verification random number generator is configured for synchronized time stamp generation with a user random number generator of the user device based on the exchanged seed information and
the data verification module is configured to determine, whether the user time information and the user time stamp of the authenticated digital data correspond to the verification time information and the correlating verification time stamp.

16. The remote device of claim 15, further comprising a data repository database, wherein the data verification module is further configured to store the authenticated digital data in a data repository database upon successful verification.

17. The remote device of claim 16, further comprising an audit database, wherein the data verification module is further configured to encrypt the authenticated digital data and to store the encrypted digital data in an audit database upon successful verification.

18. The remote device of claim 16 or 17, wherein the data verification module is further configured to assign the authenticated digital data a serial data identifier and to store the serial data identifier with the authenticated digital data.

19. The remote device of claim 16 or 17, further comprising a transaction log database, wherein the data verification module is configured to store at least a predefined user device identifier received from the user device, the metadata and the serial data identifier in a transaction log database.

20. A computer-implemented method of secure remote authentication of acquired data using at least a user device comprising:
exchanging, using the user device, seed information with a security managing device to provide synchronized time stamp generation with the security managing device,
acquiring, using the user device, digital data,
generating, using the user device, metadata with at least user time information upon acquisition of the digital data,
generating, using the user device, at least one user time stamp based on the exchanged seed information upon acquisition of the digital data,
providing, using the user device, authenticated digital data from at least the acquired digital data, the metadata and the user time stamp and
transmitting, using the user device, the authenticated digital data to the security managing device.

21. The method of claim 20, wherein metadata is generated, using the user device, upon acquisition of the digital data with at least the user time information and location information.

22. The method of claim 20, wherein metadata is generated, using the user device, upon acquisition of the digital data with at least the user time information, location information and a predefined user device identifier.

23. The method of claim 20, wherein prior to the step of exchanging seed information at least a transmission encryption key is generated during an initialization stage.

24. The method of claim 23, wherein the transmission encryption key is generated using an encrypting one time password protocol.

25. The method of claim 23 or 24, wherein prior to transmitting the authenticated digital data and using the user device, encrypting the authenticated digital data using the transmission encryption key.

26. The method of claim 23, wherein the initialization stage comprises:
providing, using the user device, device information of one or more parameters of the user device and
transmitting, using the user device, the device information to the security managing device for determining whether the device information corresponds to predefined device attestation information, so that the transmission encryption key is only generated in case the device information corresponds to the predefined device attestation information.

27. The method of claim 20, wherein said digital data is multimedia digital data.

28. A computer-readable medium including contents that are configured to cause a computing system to conduct the method of claim 20.

29. A user device forming part of a system of secure remote authentication of acquired data, comprising
a data gathering module for acquiring digital data,
a metadata generator for providing metadata with at least user time information upon acquisition of the digital data,
a user random number generator for generating a user time stamp at least upon acquisition of the digital data,
a user authenticating module and
a communication interface for communicating with a security managing device, wherein
the user device is configured to exchange seed information with the security managing device,
the user random number generator is configured for synchronized time stamp generation with a verification random number generator of the security managing device based on the exchanged seed information,
the user authenticating module is configured for providing authenticated digital data from at least the acquired digital data, the metadata and the generated user time stamp and
the communication interface is configured to transmit the authenticated digital data to the security managing device.

30. The user device of claim 29, further comprising a positioning module providing location information, so that the metadata generator provides metadata with at least the user time information and the location information.

31. The user device of claim 29, further comprising a predefined user device identifier, so that the metadata generator provides metadata with at least the user time information, location information and the predefined user device identifier.

32. A computer-implemented method of secure remote authentication of acquired data using at least a user device and a security managing device comprising:
exchanging between the user device and the security managing device seed information,
generating synchronized random number time stamps on both devices based on the exchanged seed information, wherein at least one user time stamp is generated on the user device and at least a verification time stamp is generated on the security managing device,
correlating, using the security managing device, the generated verification time stamp with verification time information,
acquiring, using the user device, digital data,
generating, using the user device, metadata with at least user time information upon acquisition of the digital data,
generating, using the user device, the user time stamp upon acquisition of the digital data,
providing, using the user device, authenticated digital data from at least the acquired digital data, the metadata and the user time stamp,
transmitting, using the user device, the authenticated digital data to the security managing device,
verifying, using the security managing device, upon reception of the authenticated digital data, whether the user time information and the user time stamp of said authenticated digital data correspond to the verification time information and the correlating verification time stamp.

33. The method of claim 32, wherein upon successful verification further storing the authenticated digital data in a data repository database.

34. The method of claim 33, wherein upon successful verification further encrypting the authenticated digital data and storing the encrypted digital data in an audit database.

35. The method of claim 33 or 34, wherein prior to storing the authenticated digital data and using the security managing device, assigning the authenticated digital data a serial data identifier and storing the serial data identifier with the authenticated digital data.

36. The method of claim 32, wherein metadata is generated, using the user device, upon acquisition of the digital data with at least the user time information and location information.

37. The method of claim 32, wherein metadata is generated, using the user device, upon acquisition of the digital data with at least the user time information, location information and a predefined user device identifier.

38. The method of claim 37, wherein upon storing the authenticated digital data and using the security managing device, storing at least the predefined user device identifier, the metadata and the serial data identifier in a transaction log database.

39. The method of claim 32, wherein prior to the exchange of seed information at least a transmission encryption key is generated during an initialization stage.

40. The method of claim 39, wherein the transmission encryption key is generated using an encrypting one time password protocol.

41. The method of claim 39 or 40, wherein the step of exchanging seed information comprises, using the security managing device:
generating the seed information,
encrypting the seed information with the transmission encryption key and
transmitting the encrypted seed information to the user device.

42. The method of one of claims 39-41, wherein prior to transmitting the authenticated digital data and using the user device, encrypting the authenticated digital data using the transmission encryption key.

43. The method of claim 42, wherein prior to verifying that the user time information and the user time stamp correspond to the verification time information and the verification time stamp, decrypting the encrypted authenticated digital data using the transmission encryption key.

44. The method of claim 39, wherein the initialization stage comprises:
providing, using the user device, device information of one or more parameters of the user device,
transmitting, using the user device, the device information to the security managing device,
determining, using the security managing device, whether the received device information corresponds to predefined device attestation information, so that the transmission encryption key is only generated in case the received device information corresponds to the predefined device attestation information.

45. The method of claim 44, wherein upon reception of the device information using the security managing device, the device information is further stored in the transaction log database.

46. The method of claim 45, further comprising the step of determining, using the security managing device, whether the received device information corresponds to stored device information comprised in the transaction log database, so that the transmission encryption key is only generated, in case the received device information corresponds to stored device.

47. The method of claim 32, wherein said digital data is multimedia digital data.

48. A computer-readable medium including contents that are configured to cause a computing system to conduct the method of claim 32.

49. System of secure remote authentication of acquired data, with
a user device comprising
a data gathering module for acquiring digital data,
a metadata generator for providing metadata with at least user time information upon acquisition of the digital data,
a user random number generator for generating at least one user time stamp upon acquisition of the digital data,
a user authenticating module for providing authenticated digital data from at least the acquired digital data, the metadata and the generated user time stamp and
a first communication interface for transmitting the authenticated digital data and
a remote device with a security managing device comprising
a second communication interface, adapted to communicate with the user device,
a verification random number generator for generating at least one verification time stamp and correlating the verification time stamp with verification time information and
a data verification module, wherein
the user device and the security managing device are configured to exchange seed information,
the user random number generator and the verification random number generator are configured for synchronized time stamp generation based on the exchanged seed information and
the data verification module is configured to determine, whether the user time information and the user time stamp of the authenticated digital data correspond to the verification time information and the correlating verification time stamp.
